(19) United States
(12) Patent Application Publication
(10) Pub. No.: US 2024/0335916 A1
(43) Pub. Date: Oct. 10, 2024

(54) MODULAR FIXTURE FOR INDUSTRIAL TOOLING

(71) Applicant: Mundo-Tech, Inc. dba Fixtur3d Solutions, Rogers, AR (US)

(72) Inventor: Christopher G. HARBAUGH, Rogers, AR (US)

(21) Appl. No.: 18/628,221

(22) Filed: Apr. 5, 2024

Related U.S. Application Data
(60) Provisional application No. 63/496,821, filed on Apr. 18, 2023.
(60) Provisional application No. 63/494,992, filed on Apr. 7, 2023.

(51) Int. Cl. B23Q 1/25

(52) U.S. Cl. CPC B23Q 1/25

(57) ABSTRACT

A fixture assembly for industrial tooling is disclosed herein. The fixture assembly includes a base plate and a plurality of support fixtures each removably coupled to the base plate. The support fixtures are repositionable along the base plate providing a modular and customizable fixture assembly.

### CROSS REFERENCE TO RELATED APPLICATIONS

This application claims the benefit of U.S. Provisional Applications 63/496,821, filed Apr. 18, 2023, and 63/494,992, filed Apr. 7, 2023. Each of these applications is incorporated by reference in their entireties for all purposes.

### BACKGROUND

Industrial tooling fixtures are devices used to hold, position, and guide workpieces or tools during manufacturing processes. They are typically designed and built specifically for a particular application and are an essential component of many manufacturing processes, including milling, drilling, turning, boring, reaming, tapping, and grinding. Tooling fixtures are also used as a gauge for workpiece validation to ensure that manufactured parts meet required specifications.

Tooling fixtures are usually made of metal, such as steel or aluminum, and can be designed to withstand the high forces and stresses generated by machining operations. They may include various types of clamps, pins, and guides to hold the workpiece in place, as well as precision alignment features to ensure accuracy and repeatability.

Industrial tooling fixtures play a critical role in ensuring the quality, efficiency, and safety of many manufacturing processes, and are an essential component of modern industrial production. However, many fixture assemblies are very large and expensive to manufacture. There is a need in the art for modular fixture assemblies that allow for various parts and components to be interchangeable, require less room to store and transport, and reduce manufacturing time and cost.

### SUMMARY

In some implementations, the techniques described herein relate to a fixture assembly for industrial tooling including: a base plate, a plurality of support fixtures each removably coupled to the base plate, each of the plurality of support fixtures including a including a saddle sized and configured to receive a workpiece, the saddle of each of the plurality of support fixtures has a size, shape and/or orientation that varies from the saddle of another one of the plurality of support fixtures, wherein each of the plurality of support fixtures are repositionable along the base plate (e.g., the plurality of support fixtures are repositionable on the base plate to provide a customizable fixture assembly used in industrial tooling).

In some implementations, the plurality of fixture members includes a first fixture member and a second fixture member, where the saddle of the first fixture member has a size, shape and/or orientation different from a size, shape and/or orientation of the saddle of the second fixture member.

In some implementations, at least one of the plurality of support fixtures is constructed from a material including polymer, metal, paper/cellulose-based material, and combinations thereof.

In some implementations, each of the plurality of support fixtures includes a body portion extending between the saddle and a support foot sized and configured to couple the support fixture to the base plate.

In some implementations, the body portion extends in a direction transverse to the support foot and/or the base plate.

In some implementations, at least one of the plurality of support fixtures includes a first body portion extending between a first saddle and the support foot and a second body portion extending between a second saddle and the support foot.

In some implementations, a bottom surface of the support fixture is sized and configured to align with a top surface of the base plate such that the support fixture can be securely coupled to the base plate.

In some implementations, the support foot includes a fastener element sized and configured to receive a fastener for coupling the support fixture to the base plate.

In some implementations, the fastener includes a pin, bolt, screw, clip, lock, or any other mechanical connector suitable for removably coupling the support fixture to the base plate.

In some implementations, the fastener extends at least partially through the support foot and into the base plate.

In some implementations, the saddle includes a contoured surface.

In some implementations, the saddle extends in a direction parallel and/or transverse to a bottom surface of the support fixture and/or a top surface of the base plate.

In some implementations, the saddle extends in a direction parallel and/or transverse to a side surface of the support fixture and/or a side surface of the base plate.

In some implementations, the saddle is movable with respect to the support foot of the support fixture.

In some implementations, at least one of the plurality of support fixtures and/or base plate includes a clamp for retaining a workpiece against the saddle.

In some implementations, at least one of the plurality of support fixtures includes a cap coupled to the body portion for securing a workpiece within the saddle.

In some implementations, a surface of the saddle is formed within a desired tolerance.

In some implementations, the support fixture includes a sensor.

In some implementations, the fixture assembly further includes a reference key coupled to the support fixture.

In some implementations, the base plate includes a plate fastener element sized and configured to receive a fastener for removably coupling the support fixture to the base plate.

In some implementations, the plate fastener element includes a plurality of plate fastener elements.

In some implementations, the plate fastener element includes a through hole extending through the base plate.

In some implementations, the plate fastener element includes a threaded opening extending into the base plate.

In some implementations, the plate fastener element includes an alternating pattern of threaded openings and through holes.

In some implementations, the plate fastener element includes a plurality of plate fastener elements arranged in a repeating pattern along the base plate.

In some implementations, the base plate is constructed from a material including a polymer, metal, paper/cellulose-based material, and combinations thereof.

In some implementations, the techniques described herein relate to a method of producing a fixture assembly for industrial tooling, the method including: providing a base plate including a plurality of fixture elements; determining a workpiece pattern, where the workpiece pattern includes a direction along at least one of the three axes of the fixture assembly coordinate system; determining a support fixture pattern corresponding to the workpiece pattern, where the support fixture pattern includes a direction along at least one of the three axes of the fixture assembly coordinate system corresponding to the direction of the workpiece pattern at a corresponding location; identifying a support fixture having a support fixture pattern portion corresponding to at least a portion of the workpiece pattern; identifying a location of the support fixture on the base plate where the support fixture pattern portion corresponds with the portion of the support fixture pattern (at the associated location defined by the fixture assembly coordinate system); and removably coupling the support fixture to the base plate at the identified location.

In some implementations, the method further includes: identifying a plurality of support fixtures having a support fixture pattern portion (e.g., the three-dimensional saddle position, orientation, and/or curvature) corresponding to at least a portion of the support fixture pattern; identifying a location of each of the plurality of support fixtures on the base plate where the support fixture pattern portion corresponds with the portion of the support fixture pattern (at the associated location defined by the fixture assembly coordinate system); and removably coupling the plurality of support fixtures to the base plate at the identified location such that the support fixture pattern portion of adjacent ones of the plurality of support fixtures corresponds to a corresponding portion of the support fixture pattern.

In some implementations, the plurality of support fixtures are arranged on the base plate such that the support fixture pattern portion of each of the plurality of the support fixtures corresponds to a (sequential) segment of the support fixture pattern.

In some implementations, each of the plurality of support fixtures are arranged on the base plate such that the saddle of each of the plurality of support fixtures forms a continuous saddle surface along the support fixture pattern.

In some implementations, each of the plurality of support fixtures are arranged along the base plate such that a saddle of a first support fixture of the plurality of support fixtures is spaced from a saddle of a second support fixture of the plurality of support fixtures such that a space is provided between the saddle of the first support fixture and the saddle of the second support fixture.

In some implementations, the method further includes confirming the location of the support fixture and/or the support fixture pattern of a given support fixture.

In some implementations, removably coupling the support fixture to the base plate includes: advancing a fastener within a fastener element in the support fixture and into the base plate; removably coupling the fastener with at least one of the fastener element in the support fixture and/or a plate fastener element in the base plate.

In some implementations, the techniques described herein relate to a method of producing a workpiece using an industrial tooling fixture assembly: providing a base plate including a plurality of fixture elements (e.g., through hole, threaded opening, recessed opening); determining a workpiece pattern, where the workpiece pattern includes a direction along at least one of the three axes of the fixture assembly coordinate system; determining a support fixture pattern corresponding to the workpiece pattern, wherein the support fixture pattern includes a direction along at least one of the three axis of the fixture assembly coordinate system corresponding to the direction of the workpiece pattern at a corresponding location; identifying a support fixture having a support fixture pattern portion corresponding to a least a portion of the support fixture pattern; identifying a location of the support fixture on the base plate where the support fixture pattern portion corresponds with the portion of the support fixture pattern (at the associated location defined by the fixture assembly coordinate system); removably coupling the support fixture to the base plate at the identified location; providing a workpiece to the support fixture; and positioning the workpiece within a saddle provided on the support fixture such that the workpiece is positioned within the saddle along the support fixture pattern and/or workpiece pattern.

In some implementations, alignment of the workpiece within the saddle of each of the plurality of saddles confirms that the workpiece is provided within the allowed tolerance of the workpiece pattern.

In some implementations, the method further includes: performing a manufacturing step on the workpiece provided within the saddle of the support fixture; wherein the manufacturing step includes at least one of: trimming, cutting, bending (e.g., deforming, flexing, crimping), welding, threading, boring, polishing, braising, compressing, applying a surface treatment or coating on the outer or inner surface of the workpiece and/or providing any other manufacturing process/step to the workpiece; coupling the workpiece to another fixture component; and/or retaining the workpiece within the saddle/support fixture (e.g., using a support fixture cap).

In some implementations, the workpiece includes at least one of plastic, metal, and/or composite rods or tubing, rigid or flex hosing.

### BRIEF DESCRIPTION OF THE DRAWINGS

FIG. 1 is a perspective view of an example fixture assembly.

FIG. 2 is an enlarged perspective view of the fixture assembly of FIG. 1.

FIG. 3 is an enlarged perspective view of the support fixture and base plate of FIG. 1.

FIG. 4 is a side view of the support fixture and base plate of FIG. 3.

FIG. 5 is a top view of the support fixture and base plate of FIG. 3.

FIG. 6 is a top view of the fixture assembly of FIG. 1.

FIG. 7 is a perspective view of an example fixture assembly.

FIG. 8 is an enlarged perspective view of the fixture assembly of FIG. 7.

FIG. 9 is a top view of the fixture assembly of FIG. 8.

FIG. 10 is a top view of the fixture assembly of FIG. 7.

FIG. 11 is a partial perspective view of an example fixture assembly.

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

### DETAILED DESCRIPTION

Referring generally to the figures, disclosed herein is a modular fixture for industrial tooling and methods of making and using the same.

In some implementations, the fixture assembly can be used to securely position and locate the workpiece in a particular position and/or orientation so that an additional manufacturing task and/or validation step can be performed. For example, in some implementations, a workpiece can be secured to the fixture assembly and an additional manufacturing step such as milling, drilling, turning, boring, reaming, tapping, and/or grinding is performed on the workpiece. In other examples, the fixture assembly is used as a validation gauge to ensure a manufactured workpiece meets the required specifications. For example, the present fixture assembly can be used as a gauge or a “go-no-go” gauge to ensure that a manufactured workpiece meets the required specifications, i.e., whether the manufactured coordinates with desired workpiece pattern (within a certain tolerance). As a “go-no-go gauge” the fixture assembly is a precision measuring tool that provides a simple, binary indication of whether a part is within tolerance or not.

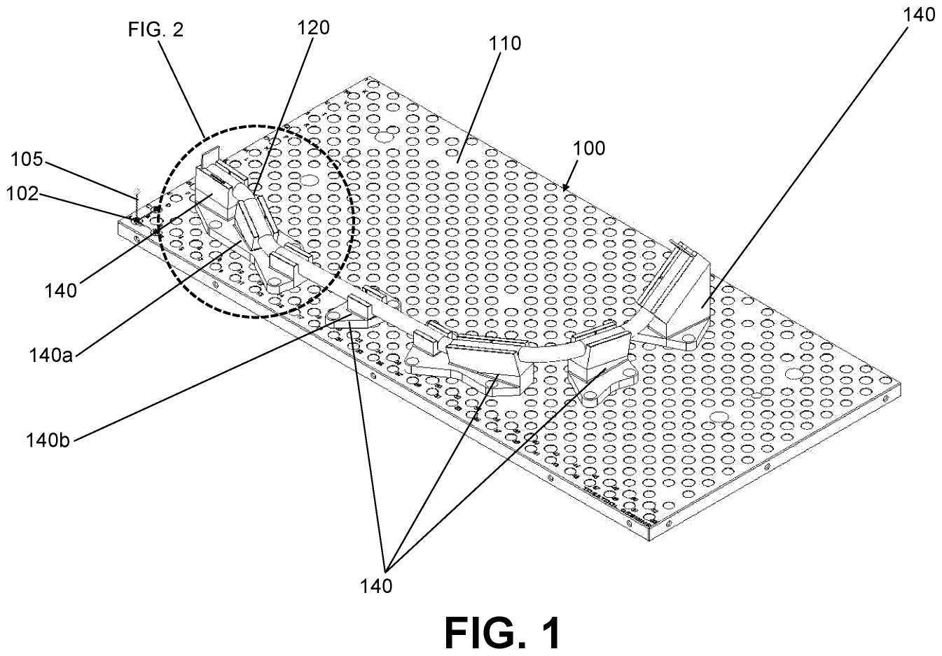

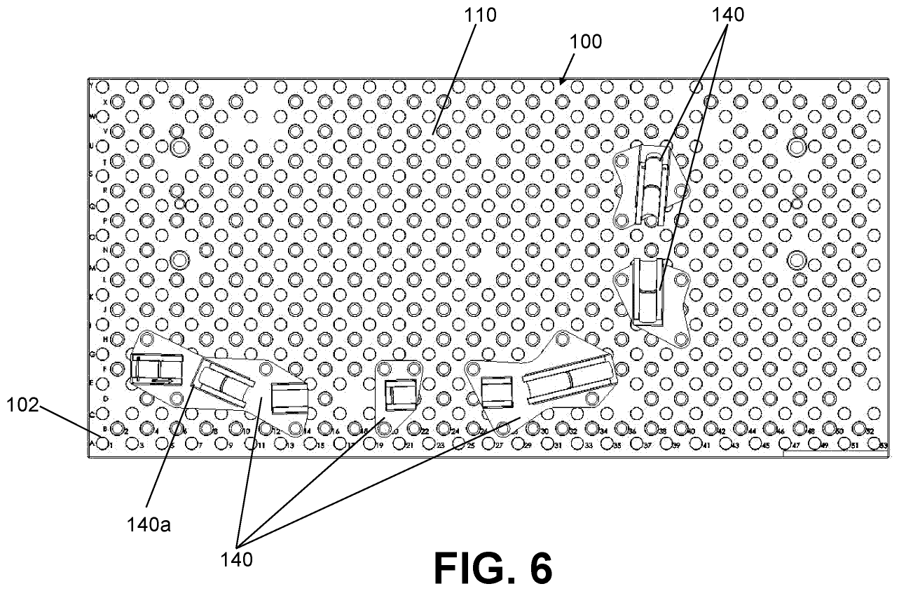

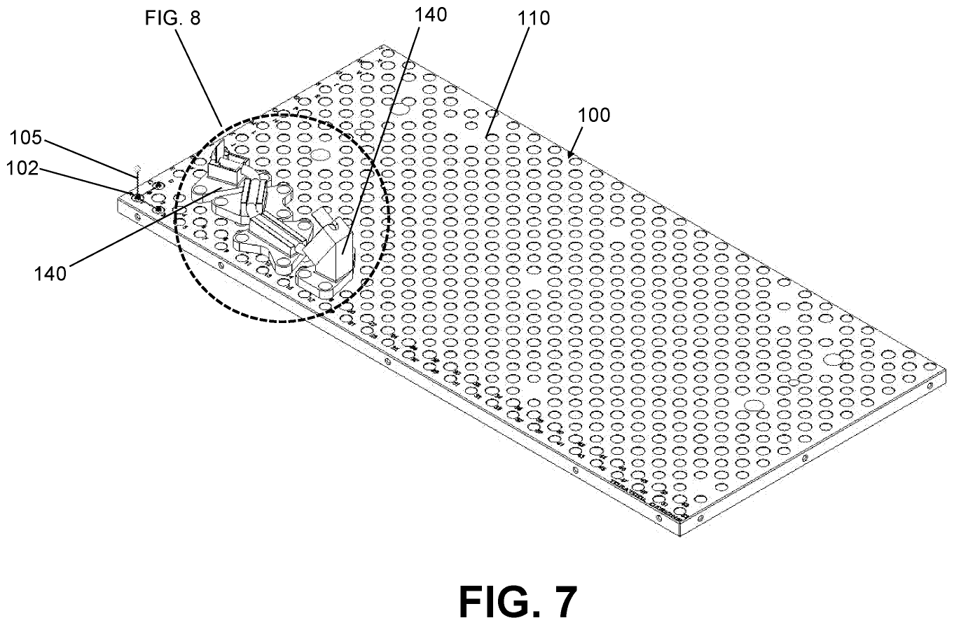

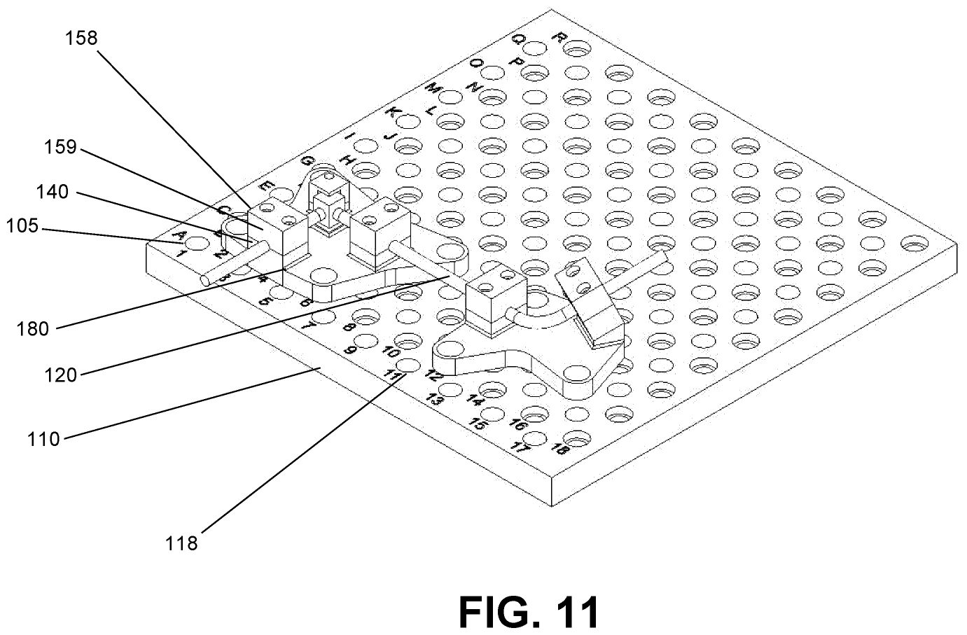

FIG. 1 is a perspective view of an example fixture assembly 100. FIGS. 7 and 11 are perspective views fixture assemblies 100 according to other examples. Though different in configuration, it is contemplated that each of the fixture assemblies 100 if FIGS. 1-11 includes like features, similar reference characters identify corresponding elements throughout.

As described herein, the fixture assembly 100 includes a base plate 110 and a plurality of support fixtures 140 sized and configured to receive a workpiece 120 during a manufacturing and/or validation process. Each of the plurality of support fixtures 140 are removably coupled to and repositionable along the base plate 110. For example, each of the plurality of support fixtures 140 are repositionable on the base plate 110 to provide a customizable fixture assembly 100 for use in industrial tooling. As such, the various support fixtures 140 are interchangeable and repositionable between different desired workpiece patterns, for example, the plurality of support fixtures 140 positional in a first pattern to accommodate a first workpiece, and the plurality of support fixtures 140 positional in a second pattern to accommodate a second workpiece. Accordingly, the disclosed modular fixture assembly 100 provides for an assembly where various support fixtures 140 can be used interchangeably with difference desired workpiece patterns providing an assembly that is modular, reduces manufacturing cost and time associated with producing additional support fixtures 140, requires fewer and smaller components necessitating less storage space, and for allows components (for example, support fixtures 140, base plates 110) to be reused.

In some implementations, each of the plurality of support fixtures includes a saddle sized and configured to receive a workpiece. In some implementations, the saddle of each of the plurality of support fixtures has a size, shape and/or orientation that varies from the saddle of at least one of the remaining support fixtures. In some implementations, the saddle of one of the plurality of support fixtures has a size, shape, and/or orientation that corresponds to the saddle of at least one of the remaining support fixtures. In some implementations, more than one saddle of the plurality of support fixtures has a size, shape, and/or orientation that corresponds to the saddle of at least one of the remaining support fixtures. In some implementations, the saddle of one of the plurality of support fixtures has a size, shape, and/or orientation that varies from the saddles of all the remaining support fixtures. In some implementations, the saddle of the plurality of each of the plurality of support fixtures has a size, shape, and/or orientation that corresponds to the saddles of the remaining support fixtures.

As illustrated in FIG. 1, the fixture assembly 100 includes a plurality of support fixtures 140. As provided in FIG. 1, the example fixture assembly 100 includes five support fixtures 140. It is contemplated that fewer or more than five support fixtures 140 can be used to support a workpiece 120. For example, the fixture assembly 100 can include a first support fixture 140a and a second support fixture 140b. In some examples, the fixture assembly 100 includes a single support fixture 140. In the example fixture assembly 100 provided in FIGS. 1-6, the assembly includes five support fixtures 140 (e.g., first support fixture 140a, second support fixture 140b, third support fixture 140c, fourth support fixture 140d, fifth support fixture 140e). In the example fixture assembly 100 illustrated in FIGS. 7-10, the assembly includes four support fixtures 140 (e.g., first support fixture 140a, second support fixture 140b, third support fixture 140c, fourth support fixture 140d). In the example fixture assembly 100 illustrated in FIG. 11, the assembly includes two support fixtures 140 (e.g., first support fixture 140a, second support fixture 140b).

As described in more detail below, each of the plurality of support fixtures 140 include a saddle 142 sized and configured to receive the workpiece 120. The workpiece 120 can include, for example, plastic, metal and/or composite rods or tubing, ridged or flex hosing, or any other material or component suitable for manufacturing or validation using the fixture assembly 100. In some examples, the saddle 142 of the first support fixture 140a has a size, shape and/or orientation different from a size, shape and/or orientation of the saddle 142 of the second support fixture 140b. However, when the plurality of support fixtures 140 (e.g., first support fixture 140a and second support fixture 140b) are arranged on the base plate 110 such that the saddle 142 of each of the plurality of support fixtures 140 are aligned and arranged to receive a workpiece having a desired workpiece pattern. For example, each of the plurality of support fixtures 140 and corresponding saddles 142 are aligned and arranged according to the support fixture pattern and/or the workpiece pattern described below.

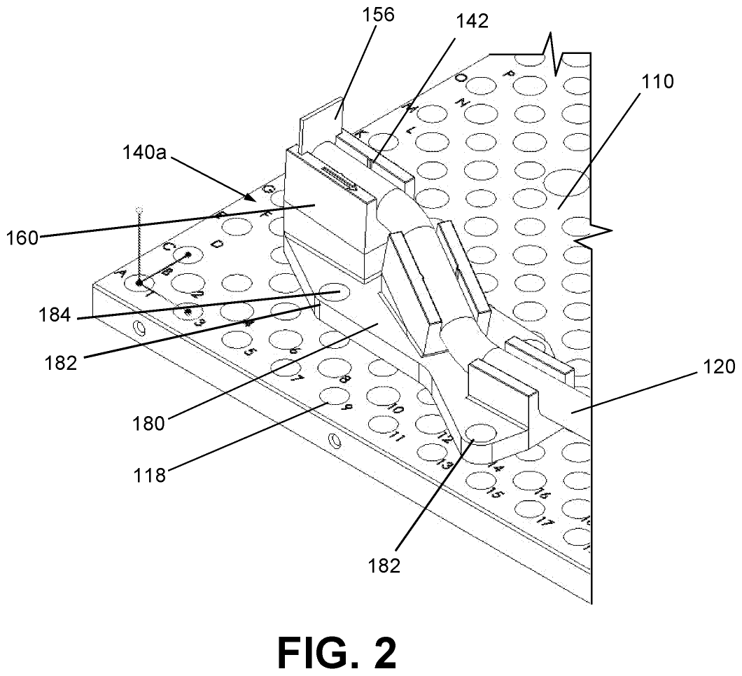

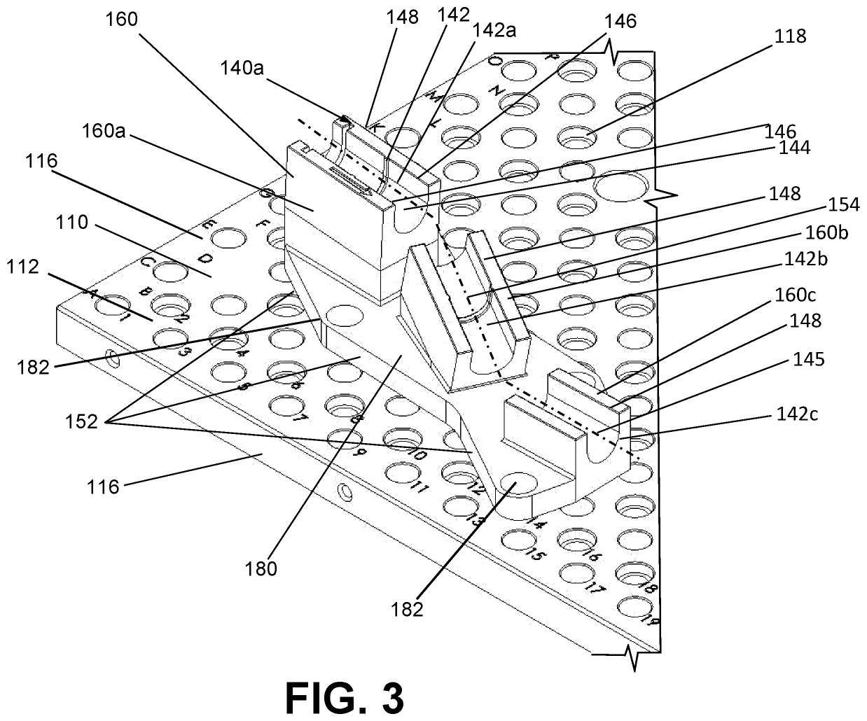

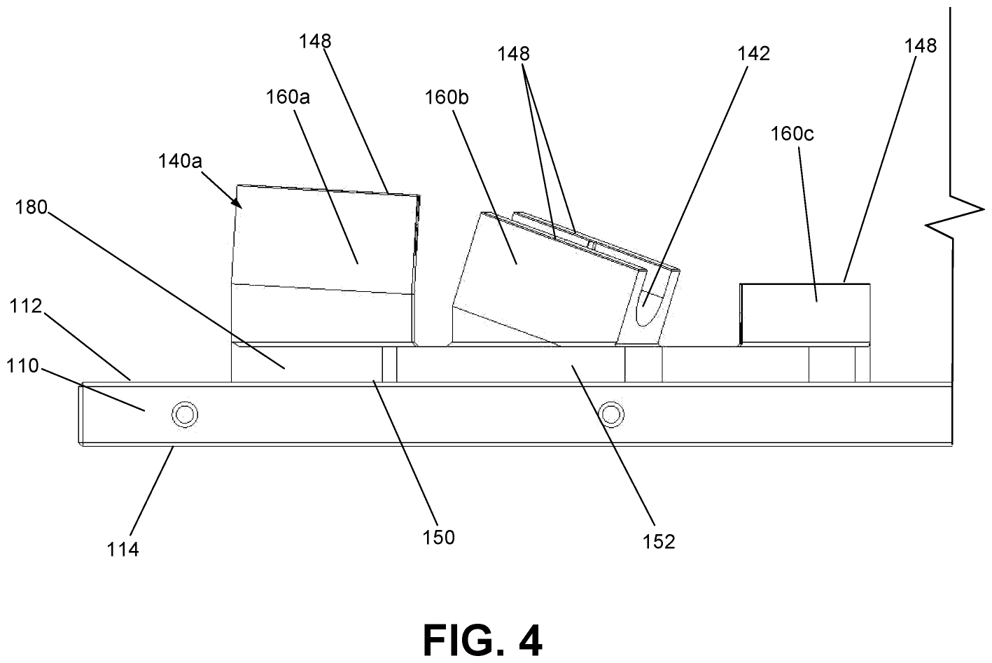

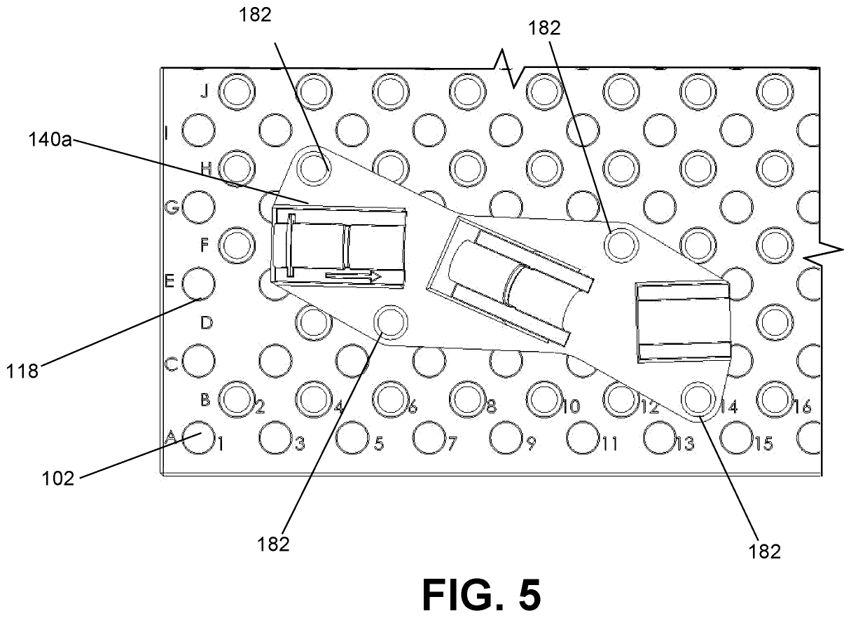

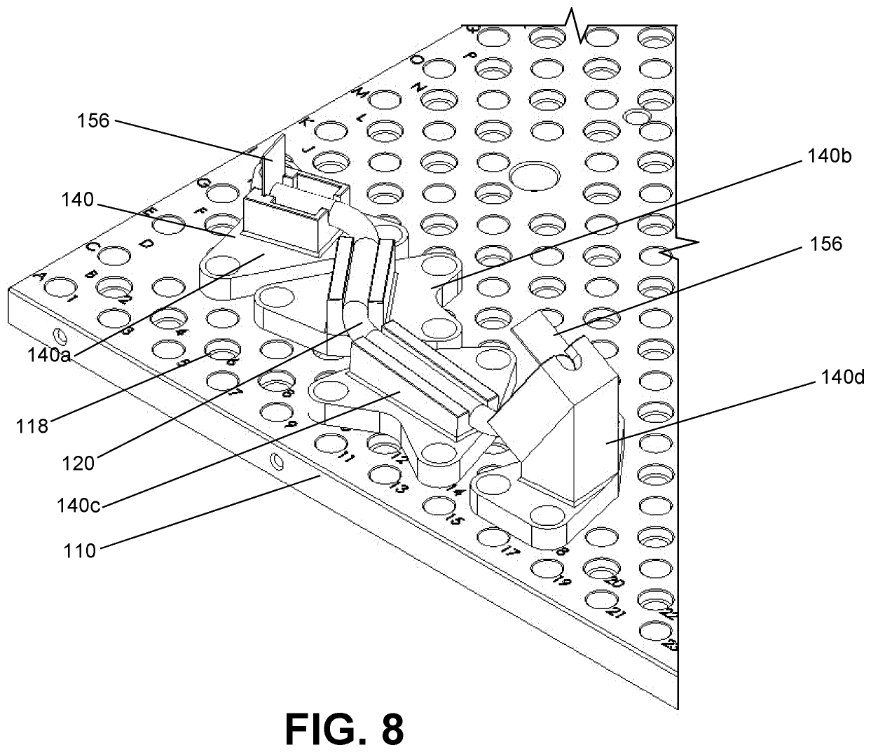

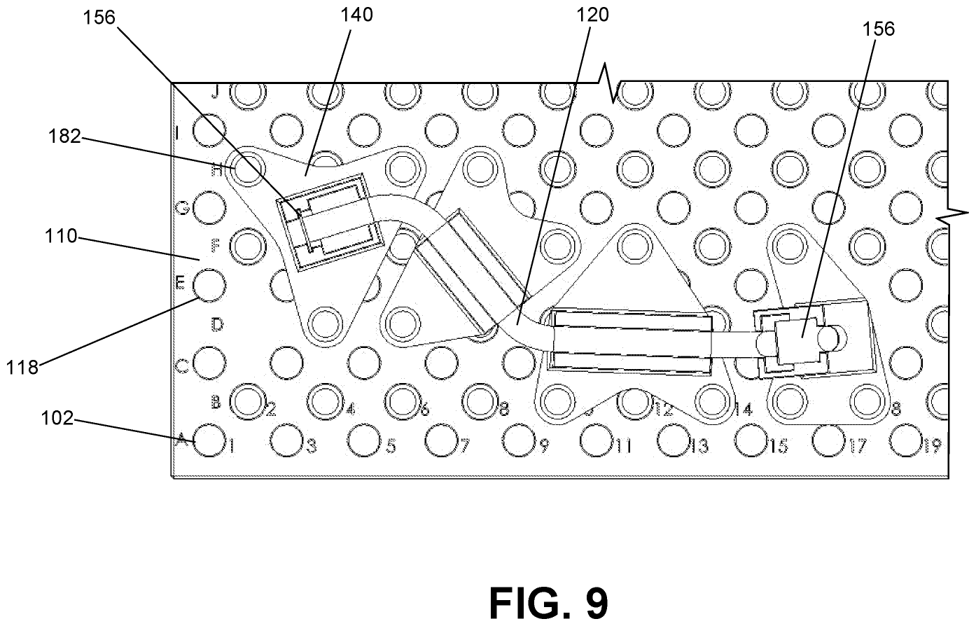

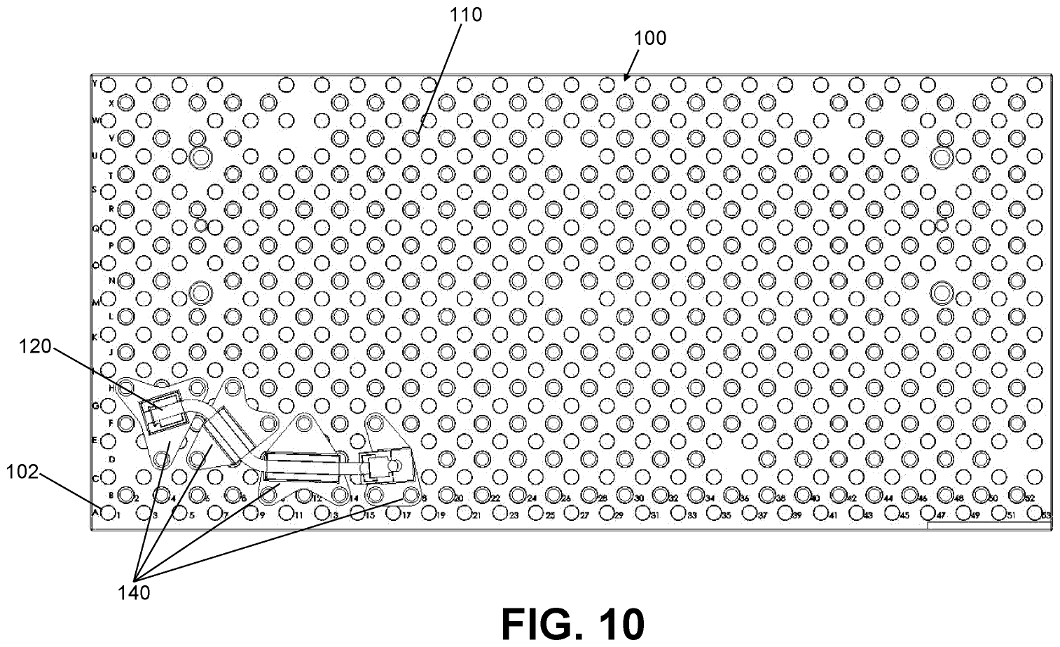

FIG. 2 is an enlarged view of a portion of the fixture assembly 100 of FIG. 1 including the workpiece 120 and FIG. 3 is an enlarged view of the portion of the fixture assembly 100 of FIG. 1 without the workpiece 120. FIG. 4 is a side view of a portion of the fixture assembly 100 of FIG. 1 and FIG. 5 is a top view of the fixture assembly 100 of FIG. 1. Similarly, FIG. 7 is a perspective view of a fixture assembly 100 according to another example. FIG. 8 is an enlarged view of a portion of the fixture assembly 100 of FIG. 7 including the workpiece 120. FIG. 9 is a top view of a portion of the fixture assembly 100 of FIG. 7 and FIG. 10 is a top view of the entire fixture assembly 100 of FIG. 7. Likewise, FIG. 11 is a perspective view of a fixture assembly 100 according to another example.

While the following description is provided in reference to the first support fixture 140a of FIG. 1, it is contemplated that like features, though possibly different in size, shape and/or orientation, are included in each of the plurality of support fixtures 140 of FIGS. 1-11.

As illustrated in FIGS. 2-4, the first support fixture 140a includes a saddle 142 sized and configured to receive a workpiece 120. For example, the saddle 142 includes a contoured surface 144 having a size and shape corresponding to a related portion of the workpiece 120, workpiece pattern and/or support fixture pattern. In some examples, the contoured surface 144 of the saddle 142 is formed within a desired tolerance. For example, as described in more detail herein, the contoured surface 144 of the saddle 142 is formed and/or machined within a desired tolerance of the workpiece pattern, support fixture pattern and/or the final workpiece 120 product. In some examples, the tolerance is +/−0.010 inches.

In some examples, the contoured surface 144 of the saddle 142 can include or define a concave surface, a convex surface, a rectilinear shaped surface, flat/straight surface, or a combination thereof. The contoured surface 144 is sized and configured to receive a corresponding portion of the workpiece 120. In some examples, the saddle 142 and/or contoured surface 144 includes a slot, recess, groove, bump, ridge, depression, and/or any other regular or irregular shaped surface. As provided in FIGS. 2 and 3, in some examples, the saddle 142 includes a planar wall surface 146 extending from opposite sides of the contoured surface 144 toward the top surface 148 of the first support fixture 140a/body portion 160 of the first support fixture 140a. In some examples, the planar wall surfaces 146 extend substantially parallel to each other, extending from opposite sides of the contoured surface 144.

In some examples, the saddle 142 extends in a direction parallel and/or transverse to a top surface 148 of the first support fixture 140a, the bottom surface 150 of the first support fixture 140a, a top surface 112 of the base plate 110, a bottom surface 114 of the base plate 110, and/or a horizontal plane defined by the fixture assembly coordinate system. Similarly, in some examples, the saddle 142 extends in a direction parallel and/or transverse to a side surface 152 of the first support fixture 140a, a side surface 116 of the base plate 110, and/or a vertical plane defined by the fixture assembly coordinate system. For example, the center line of the saddle can be defined in three dimensions relative to the support foot 180 of the first support fixture 140a, the base plate 110, and/or a reference point/fixture assembly coordinate system used to orient the first support fixture 140a/plurality of support fixtures 140, and/or base plate 110. As illustrated in FIG. 3, the center line 145 of the saddle 142 can be defined in three dimensions relative to the any portion of the first support fixture 140a, base plate 110, a reference point or fixture assembly coordinate system used or orient the fixture assembly 100 or any of its components.

In some examples, the shape, location and/or orientation of the saddle 142 is fixed with respect to the first support fixture 140a and/or the reference point/coordinate system used to locate the saddle 142. In some examples, the shape, location and/or orientation of the saddle 142 can vary, is movable or is otherwise adjustable with respect to first support fixture 140a and/or fixture assembly coordinate system. For example, in some implementations, the locations and/or orientation of the saddle 142 can be adjusted with respect to the first support fixture 140a and/or support foot 180 of the first support fixture 140a.

As illustrated in the plurality of support fixtures 140 of FIG. 1, and also in reference to the first support fixture 140a of FIGS. 2-4, each of the plurality of support fixtures 140 include a body portion 160 extending between the saddle 142 and the support foot 180. The support foot 180 is sized and configured to couple the support fixture 140 to the base plate 110. In some examples, the body portion 160 extends in a direction transverse to the support foot 180 and/or the base plate 110. As provided in FIGS. 2-4, the bottom surface 150 of the first support fixture 140a is sized and configured to align with the top surface 112 of the base plate 110 such that the first support fixture 140a can be securely coupled to the base plate 110. For example, in some implementations, the bottom surface 150 of the first support fixture 140a/support foot 180 extends in a direction generally parallel to the top surface 112 of the base plate 110 so that the bottom surface 150 of the first support fixture 140a aligns with the top surface 112 of the base plate 110.

In some examples, the support foot 180 includes a fastener element 182 sized and configured to receive a fastener 184 for coupling the first support fixture 140a to the base plate 110. In some examples, the fastener element 182 includes an opening or recess in the support foot 180 extending at least partially through the support foot 180 sized and configured to receive the fastener 184. In some examples, the fastener element 182 includes a through hole, threaded opening, recessed opening, tapered or narrowing opening. In some examples, the fastener 184 includes a corresponding pin, bolt, screw, clip, lock, or any other mechanical connector or fastener suitable for removably coupling the first support fixture 140a to the base plate 110 at the fastener element 182. In some examples, the fastener 184 extends at least partially through the support foot 180 and into the base plate 110. In some implementations, for example, the fastener 184 is a threaded screw and the fastener element 182 is a threaded opening provided in the support foot 180. The threaded screw threadedly engages the threaded opening in the support foot 180 and/or a threaded opening in the base plate 110 to securely couple the first support fixture 140a to the base plate 110.

In some examples, the support foot 180 can be configured to be coupled to the base plate 110 via a magnetic element. In some examples, the support foot 180 can be configured to be coupled to the base plate 110 via a plurality of magnetic elements. In some examples, the support foot 180 can include a magnetic element or a plurality of magnetic elements disposed throughout the support foot 180 for interfacing with a corresponding magnetic element or plurality of magnetic elements of the base plate 110. In some examples, the fastener 184 can include a magnetic element for interfacing with a corresponding magnetic element of the base plate 110. In some examples, the fastener 184 can include a magnetic element for interfacing with a corresponding magnetic element in, on, or under the base plate 110. In some examples, the fastener element 182 can include a magnetic element for interfacing with a corresponding magnetic element in the base plate 110 and/or the fastener 184. In some implementations, for example, the fastener 184 is a pin with a magnetic element (e.g., a pin with a magnet, a pin with ferromagnetic material), and the fastener element 182 is an opening provided in the support foot 180. The pin passes through the opening in the support foot and interfaces with a corresponding magnetic element (e.g., magnet, ferromagnetic material) disposed within, on, or under the base plate 110 to locate and/or securely couple the support fixture 140 to the base plate 110.

As provided in FIGS. 2-4, the first support fixture 140a can include a plurality of body portions 160 extending from the support foot 180, where each of the body portions 160 include a corresponding saddle 142. For example, as illustrated in FIG. 2, the first support fixture 140a includes a first body portion 160a, a second body portion 160b, and a third body portion 160c, each including a corresponding first saddle 142a, second saddle 142b, and third saddle 142c. Each of the body portions 160 and saddles 142 are aligned and arranged such that the saddles 142 of adjacent or sequential body portions 160 are positioned to receive the workpiece 120 having a desired workpiece pattern. For example, each of the body portions 160 and saddles 142 are aligned and arranged according to the support fixture pattern and/or the workpiece pattern described below.

In some examples, at least one of the plurality of support fixtures 140 includes a sensor 154. For example, in some implementations, at least one of the plurality of support fixtures 140 includes a sensor 154 to detect the presence of the workpiece 120 within the saddle 142. In some examples, the sensor 154 detects the location of a portion of the workpiece 120 with respect to a reference point on the support fixture 140 or the base plate 110. For example, the sensor 154 can be used to determine and/or detect the location of the end of the workpiece 120 or a particular surface of the workpiece 120. In some examples, sensor 154 includes a temperature sensor for measuring the temperature of the workpiece 120 and/or support fixture 140. In some examples, sensor 154 includes a light sensor or optical sensor for detecting the presence of a workpiece. As illustrated in FIG. 3, the sensor 154 can be located within the saddle 142. In other examples, the sensor 154 can be located elsewhere on the body portion 160, on the support foot 180 and/or on the base plate 110.

In some examples, at least one of the plurality of support fixtures 140 includes a reference key 156. The reference key 156 can be coupled to or integrally formed with the support fixture 140 and/or the base plate 110. In some examples, as illustrated in FIG. 2, the reference key 156 is positioned proximate an open end of the saddle 142. In use, when the workpiece 120 is received within the saddle 142, the reference key 156 can be used to determine if a desired location/feature of the workpiece 120 (for example, the end surface of the workpiece 120) is located correctly within the saddle 142 and along the fixture assembly 100. For example, the reference key 156 can be positioned with respect to the saddle 142 such that the location of the workpiece 120 with respect to the reference key 156 identifies if the workpiece 120 is properly positioned within the saddle 142 of each of the plurality of support fixtures 140. For example, if the end of the workpiece 120 abuts the reference key 156, and the remaining portions of the workpiece 120 fit properly within the planar wall surface 146 of each of the plurality of support fixtures 140, the user can determine that the workpiece 120 is correctly fitted within the fixture assembly 100. In some examples, the reference key 156 can be used to confirm or verify dimensions or features of the workpiece 120.

According to some implementations, the fixture assembly 100 includes a clamp or other feature for retaining the workpiece 120 within at least one of the plurality of support fixtures 140. For example, at least one of the plurality of support fixtures 140 and/or the base plate 110 can include a clamp 158 for retaining a workpiece against the saddle 142. For example, in some implementations, the clamp includes a grounding clamp for grounding a welding tool. In some examples, as shown in FIG. 11, the clamp 158 includes a cap 159 (referred to as a restraining block) for restraining the workpiece 120 within the saddle 142. The cap 159 is coupled to the body portion 160 of the support fixture 140 such that the workpiece 120 is sandwiched between the cap 159 and the body portion 160 of the support fixture 140. In some examples, the cap 159 is used to secure the workpiece 120 within the saddle 142 when it is necessary to perform an additional manufacturing process on the workpiece 120, for example adding fittings, cutting, welding on the workpiece, and/or coupling something to the workpiece.

As described herein, the plurality of support fixtures 140 are coupled to a base plate 110. In general, the base plate 110 defines a planar surface providing a secure support structure for the plurality of support fixtures 140. The base plate 110 includes at least one plate fastener element 118 sized and configured to receive a fastener 184 for removably coupling the plurality of support fixtures 140 to the base plate 110. As illustrated in the figures, the base plate 110 includes a plurality of plate fastener elements 118. As described above, the fastener 184 can include a pin, bolt, screw, clip, lock, magnet, magnetic element, or any other suitable mechanical connector or fastener for removably coupling the plurality of support fixtures 140 to the base plate 110 at the plate fastener elements 118.

In some examples, the plate fastener element 118 can include an opening or recess extending at least partially through the base plate 110. In some examples, the plate fastener elements 118 includes a through hole, threaded opening, recessed opening, and/or tapered or narrowing opening. In some examples, the each of the plurality of plate fastener elements 118 can extend in a direction perpendicular to the top surface 112, bottom surface 114 of the base plate 110, and/or a vertical or horizontal plane defined by the fixture assembly coordinate system. Similarly, each of the each of the plurality of plate fastener elements 118 can extend in a direction transverse to the top surface 112, bottom surface 114 of the base plate 110, and/or a vertical or horizontal plane defined by the fixture assembly coordinate system.

In some examples, at least one of the plate fastener elements 118 is a through hole extending through the base plate 110. In some examples, at least one of the plate fastener elements 118 is a threaded opening extending into the base plate 110. In some examples, at least one of the plate fastener elements 118 includes a ¾ inch through hole.

In some examples, the plate fastener elements 118 provided on the base plate 110 includes an alternating pattern of threaded openings and through holes. In some examples, the plate fastener elements 118 are arranged in a repeating pattern along the base plate 110. For example, the plurality of plate fastener elements 118 can be arranged in parallel rows, diagonal parallel rows, or in any regular or irregular pattern along the base plate 110. In some examples, every other row of the plate fastened elements 118 are arranged to include a through hole and a counter-sunk threaded opening as illustrated in FIG. 1. In some examples, each of the plate fastener elements 118 are arranged equidistant from an adjacent plate fastener element 118.

In some examples, the base plate 110 includes an alpha numeric label for identify each row and/or column of the plurality of plate fastening elements 118.

In some examples, at least one of the plurality of support fixtures 140 and/or the base plate 110 includes an opening for receiving a location pin used to locate and position the support fixtures 140 (or a given support fixture 140) with respect to the base plate 110/fixture assembly coordinate system. For example, the location pins can extend through an opening provided in the support foot 180 and into a corresponding opening provided in the base plate 110. In some examples, the fastener 184 provided in at least one of the fastener elements 182 and plate fastener elements 118 functions as the location pin and opening. In some examples, the location of the location pin corresponds to a reference point defined by the fixture assembly 100. That is, the location of the location pin is used as a reference point used in locating the support fixture as defined by the desired workpiece pattern and/or support fixture pattern.

In some examples, the location pin defines the origin (0, 0, 0) of the fixture assembly X, Y, Z coordinate system. In some examples, the origin of the fixture assembly coordinate system is defined at a reference opening 102 provided on the base plate 110, such that the three dimensional coordinate system 105 is defined with respect to the center axis of the reference opening 102, the planes defined by the center axis and the top surface 112 of the base plate 110, and planes parallel with the adjacent side surfaces 116 of the base plate 110. Each additional opening, fastener element 182, plate fastener element 118, saddle center line 145, contoured surface 144 and/or other features of the base plate 110 and support fixture 140 are defined with respect to the workpiece pattern/support fixture pattern in reference to the origin of the fixture assembly coordinate system 105. In some examples, each of the plurality of support fixtures 140 include a location pin for positioning the support fixtures 140 in reference to the reference opening 102/fixture assembly coordinate system 105 in accordance with the workpiece pattern/support fixture pattern.

A method of designing and producing a fixture assembly 100 for industrial tooling is described herein. In some examples, a base plate 110 is provided including a plurality of plate fastener elements 118. The base plate 110 can be formed by 3D printing, molding, machining, or other suitable manufacturing process. In some examples, the base plate 110 is formed from a material including a polymer, metal, paper/cellulose-based material, and combinations thereof. Example materials include a material suitable for 3D printing or metal manufacturing. Example materials include polylactic acid (PLA), acrylonitrile butadiene styrene (ABS), polyvinyl alcohol plastic (PVA), polycarbonate, powdered materials (e.g., polyamide (nylon), alumide), resins, metals (e.g., stainless-steel, aluminum, nitinol, bronze, gold, nickel, titanium), carbon fiber, graphite, graphene, paper, and combinations thereof. In some examples, the base plate 110 is constructed at least partially from a metal or a temperature resistant and/or stress resistant material to allow for additional fixture assembly components to be securely attached to the base plate 110 (for example, by welding).

As described above, the plate fastener elements 118 can have a uniform or varying configuration. For example, the plate fastener elements 118 can including a plurality of openings and/or recesses having different through configurations. In some examples, at least one of the plate fastener elements 118 includes an un-threaded through opening and another one of the plate fastener elements 118 is a threaded opening. As described above, the plate fastener elements 118 are arranged along the base plate 110 in a regular or irregular predetermined pattern.

A three-dimensional workpiece pattern is determined corresponding to the desired size and shape of a final workpiece 120. In some examples, the workpiece pattern corresponds to the desired three-dimensional size and shape of the final workpiece 120. For example, the workpiece pattern corresponds to the size and shape of at least a portion of the outer surface of the final workpiece 120. In some examples, the workpiece pattern is determined based on a pattern and/or model (for example, a 3D model) of the final workpiece 120. In some examples, a sample workpiece 120 is manufactured and a computer model of the workpiece pattern is determined based on the sample workpiece 120 (e.g., a computer/laser scan of the sample workpiece 120 is used to generate a 3D computer model of the workpiece pattern). In other examples, a computer model of the final workpiece 120 is created, and the computer model is used to determine the workpiece pattern. In some examples, the workpiece pattern includes a direction along at least one of the three axes of the fixture assembly coordinate system. For example, the workpiece pattern includes a direction and/or point defined in relation to at least one of the X, Y, and/or Z axis of the fixture assembly coordinate system. In some examples, the workpiece pattern is defined in reference to the origin of the fixture assembly coordinate system. As described above, the fixture assembly coordinate system can be defined in reference to an origin of the coordinate system provided at a reference opening 102 provided on the base plate and/or support fixture. In some examples, the workpiece pattern includes a vertical direction (e.g., a direction at least partially defined by the Z-axis of the fixture assembly coordinate system, a direction defined in relation to the top surface of the base plate 110), a transverse direction (e.g., a direction at least partially defined by the X-axis and/or Y-axis of the fixture assembly coordinate system, a direction in relation to a side surface of the base plate), and/or a curvature of a workpiece (e.g., a curvature at least partially defined by the X, Y and/or Z-axis). In some examples, the workpiece pattern is determined based on a pattern and/or model (e.g., a 3D model) of the final workpiece 120.

With the workpiece pattern determined, the corresponding support fixture pattern can be determined. The support fixture pattern includes the size and shape of the saddle 142, body portion 160 and/or the support foot 180 of a support fixture 140 corresponding to at least a portion of the workpiece pattern, and sized and configured to receive at least a portion of the final workpiece 120. In some examples, the support fixture pattern includes a saddle pattern corresponding to the workpiece pattern. For example, in some implementations, the support fixture pattern includes the saddle pattern (e.g., size, shape, orientation) that corresponds to a corresponding portion of the workpiece pattern, both defined in relation to the fixture assembly coordinate system. In some examples, the support fixture pattern includes body pattern for providing support to the defined saddle 142/saddle pattern. For example, in some implementations, the support fixture pattern includes the body pattern (e.g., body portion 160 and support foot 180) necessary for supporting and positioning the saddle 142/saddle pattern with respect to the base plate 110, including aligning the fastener elements 182 with corresponding plate fastener elements 118 on the base plate 110 in relation to the fixture assembly coordinate system.

In some examples, the support fixture pattern includes a direction along at least one of the three axes of the fixture assembly coordinate system corresponding to the direction of the workpiece pattern at a corresponding location. For example, the support fixture pattern includes a direction and/or point defined in relation to at least one of the X, Y, and/or Z axis of the fixture assembly coordinate system corresponding to the workpiece pattern at the same location. In some examples, like the workpiece pattern, the support fixture pattern is defined in reference to the origin of the fixture assembly coordinate system. In some examples, the support fixture pattern includes the corresponding shape of the saddle 142 formed in the fixture assembly 100. That is, the support fixture pattern defines both the shape and position of the saddle 142 with respect to the fixture assembly coordinate system.

In some examples, the support fixture pattern includes a vertical direction (e.g., a direction at least partially defined by the Z-axis of the fixture assembly coordinate system, a direction defined in relation to the top surface of the base plate 110). For example, the support fixture pattern includes the orientation and/or direction of the center line 145 and/or surface (e.g., contoured surface 144 and/or planar wall surface 146) of the of the saddle 142 in the vertical direction. In some examples, the support fixture pattern includes a transverse direction (e.g., a direction at least partially defined by the X-axis and/or Y-axis of the fixture assembly coordinate system, a direction in relation to a side surface of the base plate). For example, the support fixture pattern includes the orientation and/or direction of the center line 145 and/or surface of the saddle 142 (e.g., contoured surface 144 and/or planar wall surface 146) in the transverse direction. In some examples, the support fixture pattern includes a curvature of a portion of the support fixture 140 including, for example, the saddle 142, the body portion 160 and/or the support foot 180. (e.g., a curvature at least partially defined by the X, Y and/or Z-axis). In some examples, the curvature includes a curvature and/or a direction of curvature of the center line 145, the saddle 142, or a surface of the saddle (e.g., contoured surface 144, planar wall surface 146).

With the support fixture pattern determined, the plurality of support fixtures 140 can be formed or manufactured according to at least a portion of the support fixture pattern. In some examples, the plurality of support fixtures 140 can be formed by 3D printing, molding, machining, or other suitable manufacturing process. Similar to the base plate 110, the plurality of support fixtures 140 can be formed from a material including polymer, metal, paper/cellulose-based material, and combinations thereof. Example materials include a material suitable for 3D printing or metal manufacturing. Example material such as polylactic acid (PLA), acrylonitrile butadiene styrene (ABS), polyvinyl alcohol plastic (PVA), polycarbonate, powdered materials (e.g., polyamide (nylon), alumide), resins, metals (e.g., stainless-steel, aluminum, nitinol, bronze, gold, nickel) titanium), carbon fiber, graphite, graphene, paper, and combinations thereof. In some examples, the support fixtures 140 are constructed at least partially from a metal or a high temperature and/or high stress resistant material to allow for additional fixture assembly components to be securely attached to the support fixture 140 (e.g., by welding).

In constructing the fixture assembly 100, a support fixture 140 is identified having a portion of the support fixture pattern corresponding to a least a portion of the workpiece pattern. In some examples, a plurality of support fixtures 140 are identified having a portion of the support fixture pattern corresponding to at least a portion of the support fixture pattern.

The desired location of each of the plurality of support fixtures 140 on the base plate 110 is determined according to the support fixture pattern. For example, the location of each of the plurality of support fixtures 140 on the base plate 110 determined based on the location of the portion of the support fixture pattern (of each of the support fixtures 140) corresponding to the related portion of the support fixture pattern (each defined in reference to the fixture assembly coordinate system). For example, in reference to FIG. 1, the desired location of the first support fixture 140a is determined with respect to the support fixture pattern at a location defined by the fixture assembly coordinate system. The fastener element 182 of the first support fixture 140a is aligned with the corresponding plate fastener element 118 on the base plate 110 and the 140a coupled to the base plate 110. The step is repeated for each of the plurality of support fixtures 140.

Each of the plurality of support fixtures 140 are arranged on the base plate 110 such that the support fixture pattern portion of adjacent ones of the plurality of support fixtures 140 corresponds to a corresponding portion of the support fixture pattern. For example, each of the plurality of support fixtures 140 are located on the base plate 110 at a corresponding location along the support fixture pattern and/or workpiece pattern. As a result, disclosed implementations provide for a modular fixture assembly, such that various support fixtures 140 may be interchangeably used between various support fixture patterns, and/or various portions of a single support fixture pattern.

The plurality of support fixtures 140 are arranged on the base plate 110 such that the portion of the support fixture pattern provide by each of the plurality of the support fixtures 140 corresponds to a (sequential) segment of the support fixture pattern. For example, a first segment of the support fixture pattern corresponds with a first support fixture pattern portion of a first support fixture 140a, a second segment of the support fixture pattern corresponds with a second support fixture pattern portion of a second support fixture 140b.

As described above, in some examples, a single support fixture 140 (e.g., first support fixture 140a) includes multiple body portions 160 and corresponding saddles 142. Accordingly, a single support fixture 140 (e.g., first support fixture 140a) can include multiple portions of the support fixture pattern, each corresponding to one of the body portions 160 (first body portion 160a) and saddles 142 (first saddle 142a).

In some examples, the plurality of support fixtures 140 are arranged on the base plate 110 such that the saddle 142 of each of the plurality of support fixtures 140 form a continuous saddle surface along the support fixture pattern. For example, adjacent saddles 142 of the plurality of support fixtures 140 are positioned adjacent to each other such that the entire length of the workpiece 120 is supported by support fixtures 140.

In some examples, as illustrated in FIG. 1, the plurality of support fixtures 140 are arranged on the base plate 110 such that the saddles 142 of each of the support fixtures 140 are spaced from each other. As a result, an unsupported portion of the workpiece 120 extends between adjacent support fixtures 140. As such, in some examples, the saddle 142 of each of the plurality of support fixtures 140 do not form a continuous saddle surface along the support fixture pattern. As provided in FIG. 1, the plurality of support fixtures 140 are arranged along the base plate 110 such that the corresponding first saddle 142a of the first support fixture 140a is spaced from the second saddle 142b of the second support fixture 140b such that a space is provided between first saddle 142a and the second saddle 142b, and a portion of the workpiece 120 is unsupported by the support fixture assembly 100. In some examples, the unsupported portion of the workpiece 120 is a generally straight portion of the workpiece 120. In some examples, the unsupported portion of the workpiece 120 is a bent or curved portion of the workpiece 120. In some examples, the unsupported portion of the workpiece 120 defines an inflection point of the workpiece 120. In some examples, the unsupported portion of the workpiece 120 defines a non-critical inflection point of the workpiece 120 where conformance of the workpiece 120 with the workpiece pattern at these locations is not critical or otherwise not required.

With each of the plurality of support fixtures 140 at their desired location, the support fixtures 140 are coupled to the base plate 110. For example, a fastener 184 is advanced at least partially through the fastener element 182 on the support foot 180 and into the corresponding plate fastener element 118 on the base plate 110. In some examples the plurality of support fixtures 140 are removably coupled and repositionable with respect to the base plate 110. In some examples, the plurality of support fixtures 140 are fixedly coupled to the base plate 110.

In some examples, the location of the plurality of support fixtures 140 coupled to the base plate 110 is confirmed against the support fixture pattern and/or the workpiece pattern. For example, the location of the support fixture 140, and/or the portion of the support fixture pattern of a particular support fixture 140 is confirmed against the support fixture pattern and/or the workpiece pattern. In some examples, the location of the support fixture 140 and/or portion of the support fixture pattern of a particular support fixture 140 is determined and compared to the support fixture pattern, the workpiece pattern, and/or the fixture assembly coordinate system. In some examples, an image (e.g., a laser scan) of the fixture assembly 100 is compared against a model of the support fixture pattern and/or the workpiece pattern to determine if the assembled fixture pattern/fixture assembly 100 corresponds with the model. In some examples, the comparison between the fixture assembly 100 and the support fixture pattern and/or workpiece pattern is confirmed within an allowable tolerance limit. In some examples, if the as-constructed support fixture pattern (i.e., measured/imaged) does not correspond with the model within an allowable tolerance limit, the support fixtures 140 can be repositioned and/or replaced with a different support fixture 140.

With the plurality of support fixtures 140 positioned on the base plate 110 according to the workpiece pattern and/or the support fixture pattern, the fixture assembly 100 can be used to in a manufacturing step on a workpiece 120 and/or to validate workpiece 120 against the workpiece pattern.

For example, as described above, the workpiece 120 can provided to the plurality of support fixtures 140 such that the workpiece 120 is positioned within the saddles 142 of each of the plurality of support fixtures 140. With the workpiece 120 secured within the saddles 142, either by positioning within the saddle 142 and/or via clamp 158, an additional manufacturing step is performed on the workpiece 120. Example manufacturing steps include: coupling the workpiece 120 to another fixture component and/or workpiece 120; retaining the workpiece 120 within the saddle 142/support fixture 140 (e.g., using a support fixture cap 159); trimming, cutting, bending (e.g., deforming, flexing, crimping), welding, threading/tapping, boring, polishing, brazing, compressing, milling, drilling, turning, reaming, grinding, applying a surface treatment or coating on the outer or inner surface of the workpiece 120 and/or providing any other manufacturing process/step to the workpiece 120; and combinations thereof.

In some examples, the fixture assembly 100 is used to validate the workpiece 120 against the workpiece pattern, where alignment of the workpiece 120 within the saddle 142 of each of the plurality of support fixtures 140 confirms that the workpiece 120 is provided within the allowed tolerance of the workpiece pattern. For example, where the workpiece 120 does not fit within the saddles 142 of each of the support fixtures 140, it can be determined that the workpiece 120 was not manufactured within allowable tolerance limits of the workpiece pattern.

In some examples, the fixture assembly 100 can be used as a “go-no-go” gauge to ensure that a manufactured workpiece 120 meets the required specifications for size, shape, etc. To use the fixture assembly 100 as a “go-no-go” gauge, the workpiece 120 can be inserted into the saddle 142 of each of the plurality of support fixtures 140 and checked for proper fit. If the workpiece 120 fits properly within the saddles 142, it is within tolerance and can be considered a “go” workpiece 120. If the workpiece 120 does not fit properly, it is outside of tolerance and is considered a “no-go” workpiece 120. By providing the shape validation, the fixture assembly 100 improves quality control and reduces the risk of producing a defective workpiece 120. Use of the present fixture assembly 100 as a “go-no-go” gauge ensures that all final workpieces 120 maintain conformity and interchangeability. By quickly identifying non-conforming workpieces 120, manufacturers can reduce scrap rates, improve production efficiency, and save money.

### Configuration of Certain Implementations

The construction and arrangement of the systems and methods as shown in the various implementations are illustrative only. Although only a few implementations have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied, and the nature or number of discrete elements or positions may be altered or varied. Accordingly, all such modifications are intended to be included within the scope of the present disclosure. The order or sequence of any process or method steps may be varied or re-sequenced according to alternative implementations. Other substitutions, modifications, changes, and omissions may be made in the design, operating conditions, and arrangement of the implementations without departing from the scope of the present disclosure.

The present disclosure contemplates methods, systems, and program products on any machine-readable media for accomplishing various operations. The implementations of the present disclosure may be implemented using existing computer processors, or by a special purpose computer processor for an appropriate system, incorporated for this or another purpose, or by a hardwired system. Implementations within the scope of the present disclosure include program products including machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures, and which can be accessed by a general purpose or special purpose computer or other machine with a processor.

When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general-purpose computer, special purpose computer, or special purpose processing machines to perform a certain function or group of functions.

Although the description provides a specific order of method steps, the order of the steps may differ from what is described. Also, two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule-based logic and other logic to accomplish the various connection steps, processing steps, comparison steps and decision steps.

It is to be understood that the methods and systems are not limited to specific synthetic methods, specific components, or to particular compositions. It is also to be understood that the terminology used herein is for the purpose of describing particular implementations only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another implementation includes from the one particular value and/or to the other particular value. Similarly, when values are expressed as approximations, by use of the antecedent “about,” it will be understood that the particular value forms another implementation. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. Exemplary” means “an example of” and is not intended to convey an indication of a preferred or ideal implementation. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific implementation or combination of implementations of the disclosed methods.

### EXEMPLARY ASPECTS

In view of the described processes and compositions, hereinbelow are described certain more particularly described aspects of the disclosures. These particularly recited aspects should not, however, be interpreted to have any limiting effect on any different claims containing different or more general teachings described herein, or that the “particular” aspects are somehow limited in some way other than the inherent meanings of the language and formulas literally used therein.
Example 1. A fixture assembly for industrial tooling comprising: a base plate, a plurality of support fixtures each removably coupled to the base plate, each of the plurality of support fixtures including a saddle sized and configured to receive a workpiece, the saddle of each of the plurality of support fixtures has a size, shape and/or orientation that varies from the saddle of another one of the plurality of support fixtures, wherein each of the plurality of support fixtures are repositionable along the base plate.
Example 2. The fixture assembly of example 1, wherein the plurality of support fixtures includes a first fixture member and a second fixture member, where the saddle of the first fixture member has a size, shape and/or orientation different from a size, shape and/or orientation of the saddle of the second fixture member.
Example 3. The fixture assembly according to any example herein, particularly examples 1-2, wherein each of the plurality of support fixtures includes a body portion extending between the saddle and a support foot sized and configured to couple each of the plurality of support fixtures to the base plate.
Example 4. The fixture assembly according to any example herein, particularly example 3, wherein the body portion extends in a direction transverse to the support foot and/or the base plate.
Example 5. The fixture assembly according to any example herein, particularly examples 3-4, wherein at least one of the plurality of support fixtures includes a first body portion extending between a first saddle and the support foot and a second body portion extending between a second saddle and the support foot.
Example 6. The fixture assembly according to any example herein, particularly claims 3-5, wherein a bottom surface of at least one of the plurality of support fixtures is sized and configured to align with a top surface of the base plate such that at least one of the plurality of support fixtures can be securely coupled to the base plate.
Example 7. The fixture assembly according to any example herein, particularly examples 3-6, wherein the support foot includes a fastener element sized and configured to receive a fastener for coupling each of the plurality of support fixtures to the base plate.
Example 8. The fixture assembly according to any example herein, particularly example 7, wherein the fastener includes a pin, bolt, screw, clip, lock, or magnet.
Example 9. The fixture assembly according to any example herein, particularly examples 7-8, wherein the fastener extends at least partially through the support foot and into the base plate.
Example 10. The fixture assembly according to any example herein, particularly examples 1-9, wherein the saddle extends in a direction parallel and/or transverse to a bottom surface of each of the plurality of support fixtures and/or a top surface of the base plate.
Example 11. The fixture assembly according to any example herein, particularly examples 1-10, wherein the saddle extends in a direction parallel and/or transverse to a side surface of each of the plurality of support fixtures and/or a side surface of the base plate.
Example 12. The fixture assembly according to any example herein, particularly examples 3-11, wherein the saddle is movable with respect to the support foot of each of the plurality of support fixtures.
Example 13. The fixture assembly according to any example herein, particularly examples 1-12, wherein the plurality of support fixtures and/or base plate each include a clamp for retaining a workpiece against the saddle.
Example 14. The fixture assembly according to any example herein, particularly examples 3-13, wherein at least one of the plurality of support fixtures includes a cap coupled to the body portion for securing a workpiece within the saddle.
Example 15. The fixture assembly according to any example herein, particularly examples 1-14, wherein at least one of the plurality of support fixtures includes a sensor.
Example 16. The fixture assembly according to any example herein, particularly examples 1-15, further including a reference key coupled to at least one of the plurality of support fixtures.
Example 17. The fixture assembly according to any example herein, particularly examples 1-16, wherein the base plate includes a plate fastener element sized and configured to receive a fastener for removably coupling at least one of the plurality of support fixtures to the base plate.
Example 18. The fixture assembly according to any example herein, particularly example 17, wherein the plate fastener element includes a plurality of plate fastener elements.
Example 19. The fixture assembly according to any example herein, particularly example 18, wherein the plate fastener element includes an alternating pattern of threaded openings and through holes.
Example 20. A method of producing a fixture assembly for industrial tooling, the method comprising: providing a base plate including a plurality of fixture elements; determining a workpiece pattern, where the workpiece pattern includes a direction along at least one of the three axes of a coordinate system of the fixture assembly; determining a support fixture pattern corresponding to the workpiece pattern, where the support fixture pattern includes a direction along at least one of the three axes of the fixture assembly coordinate system corresponding to the direction of the workpiece pattern at a corresponding location; identifying a support fixture having a support fixture pattern portion corresponding to at least a portion of the workpiece pattern; and identifying a location of the support fixture on the base plate where the support fixture pattern portion corresponds with the portion of the support fixture pattern; removably coupling the support fixture to the base plate at the identified location.

Additional advantages may be learned by practice. The advantages will be realized and attained by means of the elements and combinations particularly pointed out in the appended claims. It is to be understood that the description and are exemplary and explanatory only and are not restrictive, as claimed.

1. A fixture assembly for industrial tooling comprising:
a base plate,
a plurality of support fixtures each removably coupled to the base plate, each of the plurality of support fixtures including a saddle sized and configured to receive a workpiece, the saddle of each of the plurality of support fixtures having a size, shape and/or orientation that varies from the saddle of another one of the plurality of support fixtures,
wherein each of the plurality of support fixtures are repositionable along the base plate.

2. The fixture assembly of claim 1, wherein the plurality of support fixtures includes a first fixture member and a second fixture member, where the saddle of the first fixture member has a size, shape and/or orientation different from a size, shape and/or orientation of the saddle of the second fixture member.

3. The fixture assembly of claim 1, wherein each of the plurality of support fixtures includes a body portion extending between the saddle and a support foot sized and configured to couple each of the plurality of support fixtures to the base plate.

4. The fixture assembly of claim 3, wherein the body portion extends in a direction transverse to the support foot and/or the base plate.

5. The fixture assembly of claim 3, wherein at least one of the plurality of support fixtures includes a first body portion extending between a first saddle and the support foot and a second body portion extending between a second saddle and the support foot.

6. The fixture assembly of claim 3, wherein a bottom surface of at least one of the plurality of support fixtures is sized and configured to align with a top surface of the base plate such that at least one of the plurality of support fixtures can be securely coupled to the base plate.

7. The fixture assembly of claim 3, wherein the support foot includes a fastener element sized and configured to receive a fastener for coupling each of the plurality of support fixtures to the base plate.

8. The fixture assembly of claim 7, wherein the fastener includes a pin, bolt, screw, clip, lock, or magnet.

9. The fixture assembly of claim 7, wherein the fastener extends at least partially through the support foot and into the base plate.

10. The fixture assembly of claim 1, wherein the saddle extends in a direction parallel and/or transverse to a bottom surface of each of the plurality of support fixtures and/or a top surface of the base plate.

11. The fixture assembly of claim 1, wherein the saddle extends in a direction parallel and/or transverse to a side surface of each of the plurality of support fixtures and/or a side surface of the base plate.

12. The fixture assembly of claim 3, wherein the saddle is movable with respect to the support foot of each of the plurality of support fixtures.

13. The fixture assembly of claim 1, wherein the plurality of support fixtures and/or base plate each include a clamp for retaining a workpiece against the saddle.

14. The fixture assembly of claim 3, wherein at least one of the plurality of support fixtures includes a cap coupled to the body portion for securing a workpiece within the saddle.

15. The fixture assembly of claim 1, wherein at least one of the plurality of support fixtures includes a sensor.

16. The fixture assembly of claim 1, further including a reference key coupled to at least one of the plurality of support fixtures.

17. The fixture assembly of claim 1, wherein the base plate includes a plate fastener element sized and configured to receive a fastener for removably coupling at least one of the plurality of support fixtures to the base plate.

18. The fixture assembly of claim 17, wherein the plate fastener element includes a plurality of plate fastener elements.

19. The fixture assembly of claim 18, wherein the plate fastener element includes an alternating pattern of threaded openings and through holes.

20. A method of producing a fixture assembly for industrial tooling, the method comprising:
providing a base plate including a plurality of fixture elements;
determining a workpiece pattern, where the workpiece pattern includes a direction along at least one of three axes of a coordinate system of the fixture assembly;
determining a support fixture pattern corresponding to the workpiece pattern, where the support fixture pattern includes a direction along at least one of the three axes of the fixture assembly coordinate system corresponding to the direction of the workpiece pattern at a corresponding location;
identifying a support fixture having a support fixture pattern portion corresponding to at least a portion of the workpiece pattern; and
identifying a location of the support fixture on the base plate where the support fixture pattern portion corresponds with the portion of the support fixture pattern;
removably coupling the support fixture to the base plate at the identified location.
